(19) United States
(12) Patent Application Publication
(10) Pub. No.: US 2008/0307425 A1
(43) Pub. Date: Dec. 11, 2008

(54) Data Processing System and Method

(76) Inventor: Shailendra Tripathi, Kamataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/910,244

(22) PCT Filed: Mar. 31, 2005
(86) PCT No.: PCT/IN2005/000096

§ 371 Date: Apr. 30, 2008

(51) Int. Cl. G06F 9/50

(52) U.S. Cl. 718/104

(57) ABSTRACT

A data processing system and method for reallocating resources among execution environments of the system. The reallocation of resources being performed by monitoring the utilization of the resource to determine whether or not the utilization has a predetermined relationship with a utilization measure and thereby unacceptable and based upon this determination reassigning the resource associated with a first execution environment to a second execution environment. The utilization measure is associated with the load of the processor of the utilization of the memory.

### FIELD OF THE INVENTION

The present invention relates to a data processing system and method and, more particularly, to a system and method for improved utilisation of system resources.

### BACKGROUND OF THE INVENTION

In order to increase the efficiency or utilisation of computing resources, partitioning of, for example, a server's computing resources has been developed. Partitions may be physical or logical mechanisms for providing an isolated operational environment within a single server or within multiple servers. An aim of partitioning is to support dynamic resizing of an application's resource footprint or requirements, while ensuring that all applications are protected from disruptive events that could interfere with the proper execution of the application.

Referring to FIG. 1, there is shown an overview 100 of partitioning according to the prior art. It can be appreciated that the various stages or layers of partitioning provide either an increasing degree of fault isolation from a hardware perspective or an increasing degree of flexibility from a software perspective. At one end of the spectrum, a computing resource 102 may comprise a single physical node having or running a single operating system image or a cluster of such nodes. Above the physical machine 102, a product or environment called HP nPartitions 104 can be arranged to provide hardware and software fault isolation within a single node. In the illustrated example, a number of hard partitions 106 to 110 are illustrated. A layer 112 of virtual partitions can be realised on top of, or within, each hard partition 106 to 110. It can be appreciated that one of the hard partitions 108 is shown as comprising a number of virtual partitions 114 to 118. Each virtual partition comprises a respective operating system image (not shown). Each virtual partition 114 to 118 is also imbued with or provided with software fault isolation, that is, each virtual partition 114 to 118 is arranged to isolate software executing within that environment from faults outside of that environment. FIG. 1 also illustrates a layer 120 of process resource management (PRM) together with processor sets. The PRM layer 120 shows one 116 of the virtual partitions 114 to 118 as comprising a number of applications 122 to 126. In effect the PRM layer 120 represents resource partitioning. One skilled in the art understands that hardware partitions are designed to provide hardware and software fault isolation, whereas virtual and resource partitions to provide a degree of software fault isolation together with increased flexibility in resource utilisation. Nevertheless, both hard and virtual partitions support execution of multiple images and releases of an operating system with unique parameter settings within a single node.

Hardware partitions the provide applications and operating environments with partitions that are electrically isolated and protected from one another. Hardware failures are confined to the partition in which they occur. Furthermore, hardware upgrades may require that only an affected partition be brought down rather than an entire system. Therefore, the reconfiguration or rebooting of an individual hardware partition does not require an entire system reboot. Virtual partitions are created by software to provide application and operating system isolation within a single-server node or within a single-system hard partition. Each virtual partition runs its own operating system image and can host its own applications thereby offering complete software isolation. Resource partitions are partitions with dedicated resource(s) within a single operating system image within either virtual or a hard partition. Resource partitions are unique partitions created for work load management purposes. The partitions can be run within hard partitions or virtual partitions. Granularity is defined by either a percentage share of a CPU through process resource manager (PRM) or a whole number of CPUs through processor sets (pSets).

FIG. 2 shows a comparison between a generic HP-UX server software stack 200 and a software stack 202 comprising two virtual partitions 204 and 206. Each of the two virtual partitions 204 and 206 is assigned a subset of hardware available on a respective host. Each virtual partition 204 and 206 has its own boot disk, at least one CPU and, perhaps, an I/O card, and sufficient memory to run HP-UX and the applications to be hosted within the virtual partition. As mentioned above, since each virtual partition can run its own copy of HP-UX, each is completely isolated from software errors, system panics etc. associated with other partitions. It should be noted that the virtual partition software stack 202, in addition to comprising an extra instance or copy of HP-UX, also comprises an additional layer of software 208 between the hardware/firmware and the two copies 210 and 212 of HP-UX. This layer of software 208 is known as a virtual partition monitor. The virtual partition monitor 208 manages the partitioning of the resources 214. It also loads kernels and emulates global platform resources to create the impression that each of the virtual partitions 204 and 206 is a complete or separate HP-UX system. The virtual partition monitor 208 maintains a partition database, which tracks the resources allocated to the partitions 204 and 206.

For example, the parameter settings shown in table 1 can be used to create a virtual partition named winona2 having the following resources: a total of three CPUs (two bound to be used at hardware paths 41 and 45 and one unbound CPU) with a maximum of four (bound plus unbound), 1280 MB of memory, all hardware where the path begins with 0/8 or 1/10, and the boot disk at 0/8/0/0.5.0.

TABLE 1

| Resource or Attribute | Parameter Option |
|---|---|
| Virtual partition name is winona2 | -p winona2 |
| Three total CPUs | -a cpu::3 |
| Of which two are bound CPUs and a | -a cpu:::2:4 |
| maximum of four CPUs | |
| At hardware paths 41 and 45 | -a cpu:41 -a cpu:45 |
| 1280 MB of memory | -a mem::1280 |
| All hardware where the path begins | -a io:0.8 |
| with 0/8 | |
| All hardware where the path begins | -a io:1.10 |
| with 1/10 | |
| Hardware at 0/8/0/0.5.0 as the boot | -a io:0.8.0.0.5.0:boot |
| disk | |

It is possible to migrate CPUs, or any other resource assigned to a partition, to other partitions. However, the virtual partition must be brought down in certain circumstances before changing the resources assigned to it. Virtual partitions exploit or implement the concept of “bound” and “unbound” (or “floating”) CPUs. This is required since HP-UX does not have the capability of reassigning input/output interrupts dynamically between CPUs. CPUs that have input/output interrupts assigned to them are called “bound” CPUs because they are bound to a given virtual partition when it becomes active, that is, when HP-UX is booted on the virtual partition. CPUs that are not bound to any virtual partition are called “unbound” CPUs and can be migrated between virtual partitions using an appropriate command. Once a virtual partition has been launched, the virtual partition monitor transfers ownership of a subset of a hardware to their respective partition. At that point the monitor is no longer involved in accessing input/output hardware, physical memory etc since the individual HP-UX instances have complete ownership or control of their respective hardware resources.

However, the above is unable to dynamically allocate resources among the virtual partitions without disrupting the kernel and, in turn, execution of the application.

It is an object of embodiments of the present invention to at least mitigate some of the problems of the prior art.

### SUMMARY OF INVENTION

Accordingly, there is provided a data processing system comprising a plurality of hardware resources; first and second execution environments arranged to support execution of first and second programs respectively using respective resources of the plurality of hardware resources; and means to reassign resources associated with the second execution environment to the first execution environment in response to determining that the utilisation of a resource associated with the first execution environment is unacceptable.

Advantageously, the resources of the computer can be allocated dynamically without disrupting the kernel and, in turn, the execution of the application.

Embodiments provide a data processing system in which the first and second execution environments comprise first and second virtual partitions respectively.

Embodiments provide a data processing in which at least one of the first and second resources comprises at least one of a processor, memory and an I/O device.

Embodiments provide a data processing in which the means to reassign is arranged to monitor utilisation of the first resource to determine whether or not that utilisation has a predetermined relationship with a utilisation measure and in which the means to reassign reassigns the second resource associated with the second execution environment to the first execution environment in response to determining that that utilisation has the predetermined relationship with the criterion.

Embodiments provide a data processing system in which the first resource comprise a processor and in which the utilisation measure is associated with the load of the processor.

Embodiments provide a data processing system in which the resource is memory and the utilisation measure is associated with the utilisation of the memory.

Embodiments provide a data processing system in which the means to reassign comprises a first operating system associated with the first execution environment and a second operating system associated with the second execution environment and an exception signal generator arranged to issue a first signal to the second operating system in response to determining that the utilisation of the first resource is unacceptable to cause the second operating system to relinquish control over the second resource and to issue a second signal to the first operating system to assign the second resource to the first operating system.

Embodiments provide a data processing system in which the first and second signals are interrupt signals. Embodiments are provided in which the interrupt has a priority that is at least as high as the highest priority interrupts used in the computer system or operating system such as, for example, a machine check interrupt which detects critical hardware failures. It will be appreciated that the virtual interrupts according to embodiments will be comparable in importance to such existing interrupts but will be processed differently. Therefore, existing interrupt service routines should be augmented or developed to process the new interrupts according to embodiments of the present invention.

Embodiments provide a data processing system comprising means to reassign resources associated with an execution environment to a further execution environment in response to determining that utilisation of resources associated with the further execution environment is unacceptable.

Embodiments provide a data processing system comprising a monitor to receive an output from a daemon; the daemon being arranged to monitor utilisation of a first resource associated with a first entity and to produce an output in response to detecting a predetermineable utilisation measure; an exception signal generator arranged to a generate, in response to receiving the output, a first signal associated with removal of a second resource associated with a second entity, and to generate a second signal to associate the second resource with the first entity.

Embodiments provide a data processing system comprising a daemon to monitor utilisation of a first resource associated with a first entity and to produce an output in response to detecting a predetermineable utilisation measure; an exception signal generator, responsive to the output, to produce at least a pair of a signals to disassociate a second resource from a second entity and to associate the second resource with the first entity; an operating environment such as, for example, at least one of an operating system and a respective virtual partition, to support execution of the second entity; the environment being response to receiving the signal, of the pair of signals, to disassociate second resource and the second entity to disassociate the second resource and the second entity; a further operating environment such as, for example, at least one of an operating system and a respective virtual partition, to support execution of the first entity using the first resource; the environment being response to receiving the signal, of the pair of signals, related to associating the second resource with the first entity.

Embodiments provide a data processing system comprising a plurality of hardware resources; a daemon to monitor utilisation of a first resource of the hardware resources associated with a first entity and to produce an output in response to detecting a predetermineable utilisation measure; an exception signal generator arranged to produce at least a pair of a signals to disassociate a second resource and a second entity and to associate the second resource with the first entity such that the signal of the pair of signals related to disassociating the second resource and the second entity is produced in response to the output; a virtual partition comprising a respective operating system arranged to support execution of the second entity; the operating system being arranged to disassociate the second resource and the second entity in response to the signal related to disassociating the resource associated with the second entity; a further virtual partition comprising a respective operating system arranged to support execution of the first entity using the first resource; the operating system of the further virtual environment being arranged to associate the second resource with the first entity in response to the signal related to associating the second resource with the first entity.

Embodiments provide a method for managing resources of a computer having pair of virtual partitions comprising assigned respective resources for executing respective programs; the method comprising the steps of monitoring the utilisation of the respective resources to determine whether or not at least one resource thereof has a predetermined relationship relative to a performance metric; identifying a resource that does not have such a predetermined relationship relative to the performance metric; assigning the resource not having the predetermined relationship relative to the performance metric to virtual partition associated with the resource determined as having the predetermined relationship relative to the performance metric.

Embodiments provide a data processing method for influencing allocation of resources comprising the steps of generating at least a pair of signals for disassociating a first resource from a first execution environment and associating said first resource with a second environment in response to a determination that a second resource associated with the second execution environment is overutilised.

Embodiments provide a data processing method further comprising the steps of establishing the first and second execution environments, which comprises creating first and second virtual partitions and launching respective operating systems within the first and second virtual partitions to support execution of first and second applications respectively within the first and second virtual partitions.

Embodiments provide a data processing method further comprising the step of assigning the first resource to the first partition and assigning the second resource to the second partition.

It will be appreciated that embodiments can be realised in the form of or using software. Suitably, embodiments provide a computer program comprising executable code to realise a system or method as described or claimed herein. Embodiments also provide a computer program comprising executable code means to reassign resources associated with an execution environment to a further execution environment in response to determining that utilisation of resources associated with the further execution environment is unacceptable.

The computer program is capable of being stored using optical or magnetic storage or within a device such as a memory or chip. Accordingly, embodiments provide a product comprising storage storing such a computer program.

### BRIEF DESCRIPTION OF THE DRAWINGS

Embodiments of the present invention will now be described, by way of example only, with reference to the accompanying drawings in which:

FIG. 1 shows a prior art computer system;

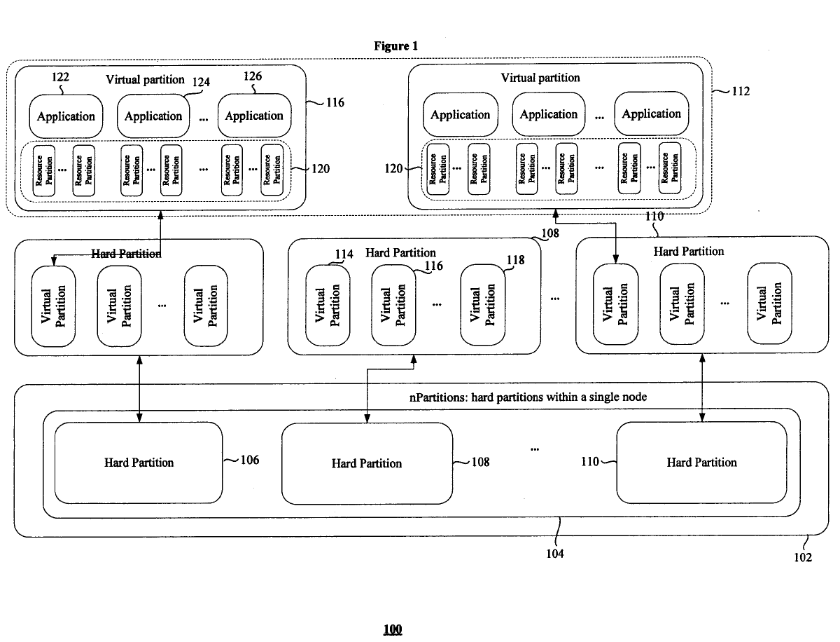

FIG. 2 illustrates a pair of prior art software stacks demonstrating partitioning;

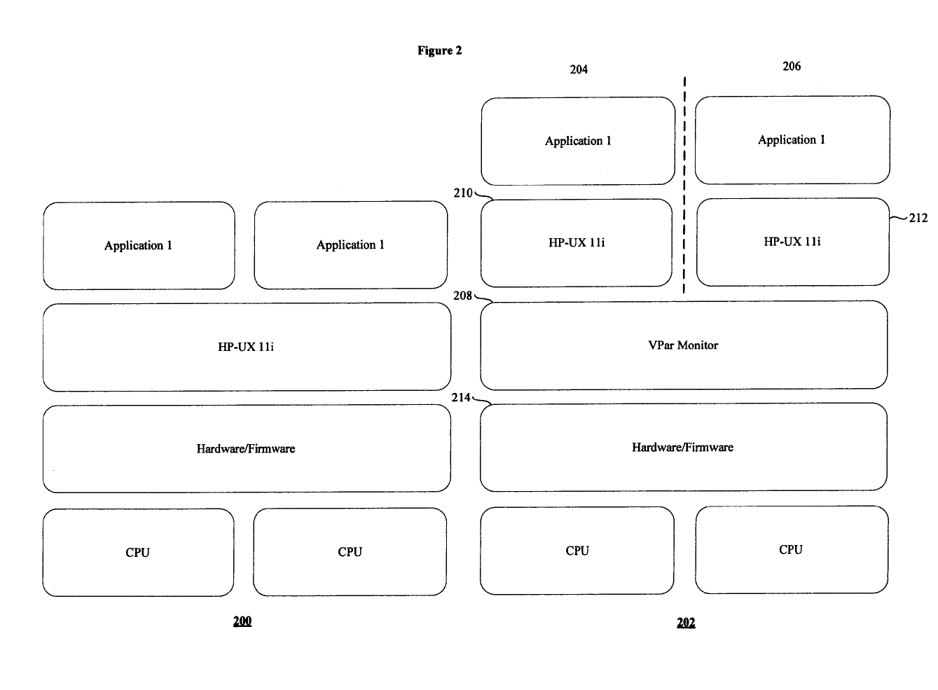

FIG. 3 depicts an embodiment of the present invention; and

FIG. 4 shows a flowchart according to an embodiment.

### DETAILED DESCRIPTION OF EMBODIMENTS

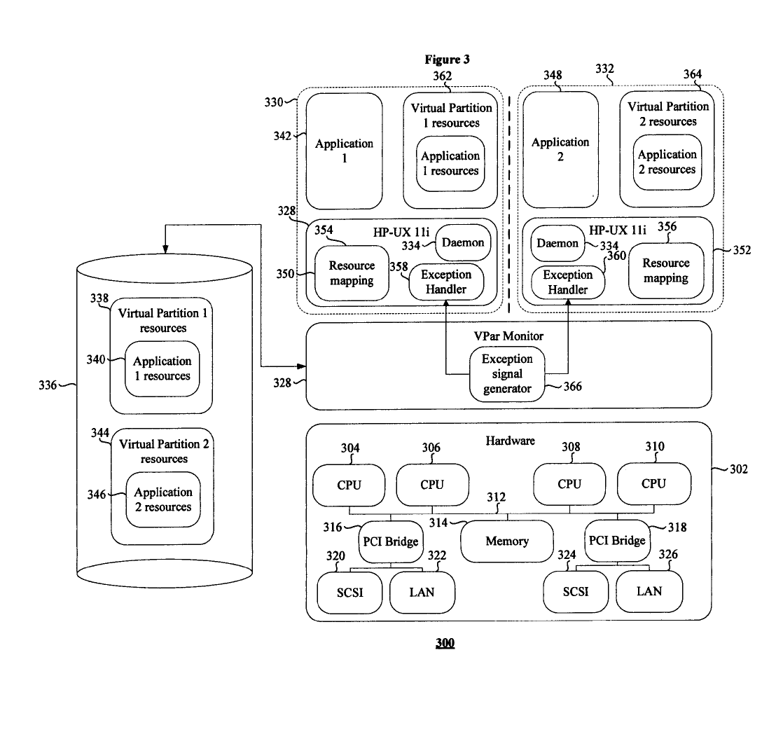

Referring to FIG. 3, there is depicted a computer system 300 comprising hardware 302 such as, for example, one or more central processing units, memory, and various other interfaces. In the illustrated example, it can be appreciated that the hardware 302 is a four way server, that is, it comprises four processors 304 to 310 connected to a bus 312. Also illustrated is a memory 314 that is shared between the processors 304 to 310. A pair of PCI bridges 316 and 318 is used to connect pairs of SCSIs and LANs 320 to 326. Although the example presented is shown as a four-way server, embodiments of the present invention are not limited to use of a server having that number of processors. Embodiments can be realised in which some of the number of processors such as, for example, 2 to 8 processors are used. Furthermore, embodiments are not limited to the hardware being a server since other embodiments can be equally well realised using some of the form of computer such as, for example, a different type of multiprocessor computer. It will also be appreciated that the illustrated hardware 302 is merely exemplary and embodiments are not limited to use with the particular form of hardware illustrated.

Running on top of the hardware 302 is a program 328 for establishing and managing a number of virtual partitions 330 and 332. The program may be, for example, Virtual Partitions available from Hewlett-Packard Co., as appropriately modified according to embodiments of the present invention. It will be appreciated that the virtual partitions represent embodiments of execution environments such as, for example, execution environments realised using software, that is, software-execution environments. Also illustrated is a program 334 monitoring the workloads of the CPUs in its partition. Embodiments of the monitoring program 334 can be realised in the form of a daemon also available from Hewlett-Packard Co. The workloads of the partitions or the utilisation of the resources such as CPUs or other resources within the partitions is managed by, for example, daemons 334 within a UNIX context. Furthermore, the virtual partitions are examples of embodiments of execution environments.

The virtual partitions program 328 is arranged to maintain a database 336 containing data associated with the virtual partitions 330 and 332. The database 336 comprises first data 338 associated with a first partition 330 of the virtual partitions. The first data 338 comprises data 340 representing an indication of the hardware resources such as, for example, the CPUs 340 to 310, the memory 314, and the various interfaces assigned to the first virtual partition 330 to support execution of an application or other program 342 within that virtual partition 330. The database 336 comprises second data 344 associated with a second partition 332 of the virtual partitions. The second data 344 comprises data 346 representing an indication of the hardware resources such as, for example, the CPUs 340 to 310, the memory 314, and the various interfaces assigned to the second virtual partition 332 to support execution of an application or other program 348 within that virtual partition 332.

Each of the virtual partitions 330 and 332 comprises a respective operating system 350 and 352. In the illustrated system 300, the operating systems 350 and 352 are both HP-UX 11i. The operating systems 350 and 352 comprises resource mapping data 354 and 356 that provides an indication of the mapping between selected respective hardware resources 304 to 326 of the hardware 302 to support execution of the applications 342 and 348 and logical representations of that selected hardware as is conventional within, for example, a UNIX operating system. The operating systems 350 and 352 also comprise exception handlers 358 and 360 that are responsive to events such as, for example, interrupts, traps and exceptions, which are embodiments of signals associated with events that can be brought to the attention of the kernels 350 and 352.

It can be appreciated that the first partition 330 also comprises a copy 362 of the data 338 representing the resources assigned to the first partition 330. It should be noted that the local copy is used so that an operating system need not interact with vPar monitor 328 to determine its resources every time it makes request to hardware. When an operating system boots, it detects the hardware resources. During operation, all requests for access to resources are intercepted by the vPar monitor 328 and the OS receives a reflection of hardware which its partition has been assigned. Then, a copy of the database is made so that OS need not interact with the hardware via vPar monitor. Only once the operating system as been assigned its limited resources can it directly interact with the hardware. Similarly, the second partition 332 also comprises a copy 364 of the data 344 representing the resources assigned to the second partition 332.

Returning to the virtual partitions monitor 328, it can be appreciated that there is provided an exception signal generator 366. The exception signal generator 366 is used to generate a pair of exception signals having a predetermined priority such as, for example, the priorities assigned to sigint, sigtrap or sigbus to use HP-UX examples. The exception signal generator 366 can direct the generated exception signal to either of the operating systems 350 and 352.

A first exception signal of the pair of exception signals is used to cause the operating system receiving the first exception signal to act or respond as if the signal was generated by the hardware 302 in response to, for example, a hardware event associated with one of the resources of the hardware 302, that is, as if the first exception signal had a priority that was at least of a comparable priority. For example, the hardware event might be failure or removal of one of the resources. In which case, the first exception signal would be an exception signal that the operating system would interpret as being associated with failure or removal of a hardware resource or as having a priority comparable with that of an interrupt associated with such a hardware event. An example of such an exception signal that is associated with failure of a hardware resource is sigbus. In effect, the first exception signal is an embodiment of a first migrate resource signal.

A second exception signal of the pair of exception signals is used to cause the operating system receiving the second exception signal to act or respond as if the signal was, again, generated by the hardware 302 in response to, for example, a hardware event associated with one of the resources of the hardware 302, that is, as if the second exception signal had a priority that was at least of a comparable priority. For example, the hardware event might be insertion of one of the resources. In which case, the second exception signal would be an exception signal that the operating system would interpret as being associated with insertion or introduction of a hardware resource or as having a priority comparable with that of an interrupt associated with such a hardware event.

Embodiments can be realised in which the first and second execption signals are the same and the interrupt service routines of the operating systems are arranged to initiate an appropriate course of action in response to the first and second exception signals, which would be reassignment or migration of resources. The determination of the appropriate course of action can be realised using parameters passed to the interrupt service routines that are associated with the removal or insertion of resources. In effect, the second exception signal is an embodiment of a second migrate resource signal.

The operating systems 350 and 352 are arranged, in response to receiving the first exception signal, to identify data representing the hardware resource associated with that exception signal within the resource mapping data 354 and 360 and to remove any such identified data according to which operating system received the first exception signal. It will be appreciated that removal of any such identification data has the effect of removing the associated resource from the respective virtual partition, that is, the resource is no longer available to support execution of any application running within that virtual partition.

The operating systems 350 and 352 are arranged, in response to receiving the second exception signal, to introduce identification or resource mapping data representing the hardware resource associated with that exception signal into the resource mapping data 354 and 360 according to which operating system received the second exception signal. It will be appreciated that the insertion of any such identification data into the resource mapping data will have the effect of making the associated hardware resource available to support execution of any application running within a respective virtual partition.

As mentioned above a daemon 334 is operable to monitor the load of the CPUs in its partition. If the daemon 334 identifies an overloaded CPU, data, or a signal representing an indication to that effect, is sent to the exception signal generator 366. The exception signal generator 366, in response to receiving such notification that the processor is overloaded, is arranged to identify, from the data 338 and 344, the operating system that is mapped to the overloaded processor. The exception signal generator 366 is then arranged to identify an operating system associated with a processor that is not overloaded. In effect, the vPars monitor 328 uses the daemons, which run in every partition in a respective operating system, to monitor the resource usage. The same mechanism is used to signal to the vPar monitor 328 that a particular partition is overloaded. The vPar monitor 328 arranges the daemons to collate usage data from the partitions. Based upon the information received, the vPar monitor selects a resource in a partition to be removed and migrated to an overloaded partition. The exception signal generator 366 is arranged to generate the first exception signal in response to receiving such a notification that a CPU is overloaded from the daemon 334. It will be appreciated that in such circumstances the first exception signal would be associated with the CPU that is not overloaded. The first exception signal is directed to the operating system that is associated with the CPU that is not overloaded, which has the effect of removing that CPU from the resources available to an appropriate one of the virtual partitions The exception signal generator 366 generates the second exception signal and directs it to the operating system that is associated with the overloaded CPU. This has the effect of making the previously underutilised CPU available as a resource within the virtual partition associated with the overutilised CPU. The operating system is arranged to make appropriate changes to the resource mapping data to reflect the availability of the migrated CPU to the virtual partition associated with the overutilised CPU.

One skilled in the art appreciates that at a lower level, the interrupt service routines suspend all activities, adjust the operating system views of available resources and then return back. Under such circumstances, the released resource can be thought of as “floating”, that is, unassigned. At this point, the partition from which the resource was removed resumes operations. Now, the vPar monitor 328 sends a signal to the other partition as if the resource has been added. In the Interrupt Service Routine, the operating system will suspend all activities and add the resource and then resume its operation.

It will be appreciated that the net effect of the generation of the first and second exception signals is to migrate a CPU from one virtual partition to another virtual partition.

Once the CPU has been migrated between virtual partitions, the virtual partition monitor 328 is arranged to make appropriate amendments to the data stored within the virtual partition database 336. For example, assuming that CPUs 304 and 306 are associated with the first virtual partition 330 and the remaining CPUs 308 and 310 are associated with the second virtual partition 332 and that a first a CPU 304 is overutilised while another CPU 308 is underutilised, will be appreciated that the underutilised CPU is 308 will be migrated to the first virtual partition 330 from the second virtual partition 332. Therefore, the data 338 representing the resources assigned to the first virtual partition 330 will be amended to reflect the insertion or availability of the CPU 308 to support the first virtual partition 330. Consequently, the data 344 for representing the resources supporting the second virtual partition 332 will be amended to reflect the removal of CPU 308.

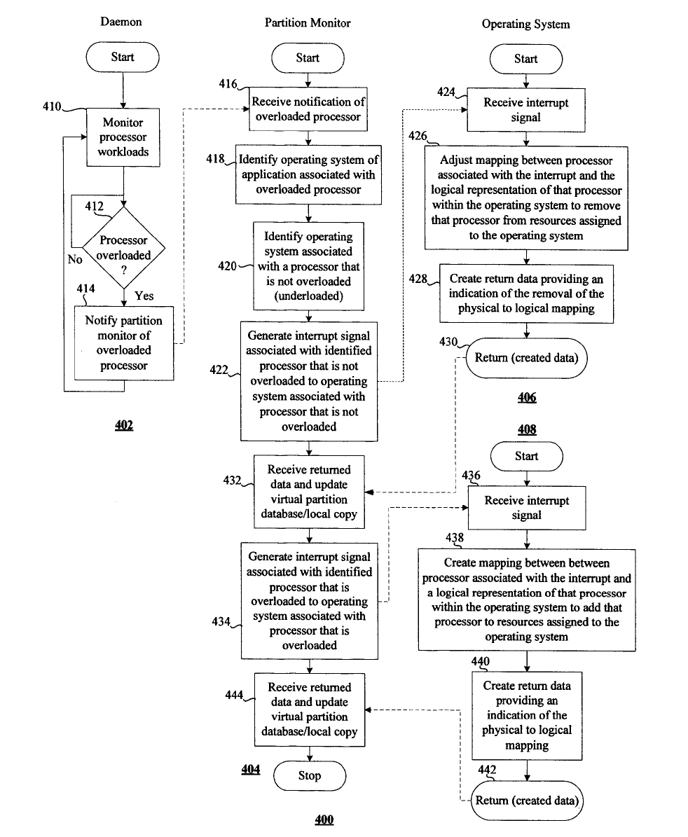

FIG. 4 shows a number of flow charts 400 of processing associated with an embodiment of the present invention. It can be seen that there is a first flow chart 402 associated with the activities of a daemon 334, a second flow chart 404 associated with the activities of the partition monitor 328, a third flow chart 406 associated with activities of the operating system and a fourth of flow chart 408 also associated with activities of an operating system.

Referring to the first flow chart 402, it can be appreciated to that the daemon 334 is arranged to assess, at step 410, the workload of the CPUs in its partition. A determination is made as to whether or not any of the monitored processors are overloaded at step 412. If the determination is negative, processing returns to step 410. If the determination is positive, the daemon 334 forwards a notification containing an indication that one or more than one of the processors is overloaded to the partition monitor or, for example, to the exception signal generator 366, at step 414.

The partition monitor 328 receives the notification that one or more of the CPUs 304 to 310 is or are overloaded at step 416. In response to receiving such a notification, the partition monitor 328, at step 418 identifies the operating system associated with the overloaded processor from the data 338 and 344 stored within the virtual partition database 336. At step 420, the partition monitor 328 identifies an operating system associated with a CPU that is not overloaded. An interrupt signal is generated by the partition monitor 328 at step 422 and forwarded to the operating system identified as having an underutilised processor.

Referring to the third flow chart 406, the interrupt signal generated at step 422 is received, at step 424, or processed by the exception handler associated with the operating system to which the interrupt was directed. In response to receiving the interrupt, the operating system to which the interrupt was directed adjusts its corresponding resource mapping data to remove the underutilised CPU from the resources supporting its virtual partition at step 426. At step 428, return data providing an indication or confirmation of the removal of the processor from the list of available resources is created. The return data is returned to the partition monitor 328 or, more particularly, to the exception signal generator 366, at step 430.

Returning to the second flow chart 404, the return data is received at step 432 and the data 338 or 344, as appropriate, stored within the virtual partition database 336 is updated to remove any indication that the underutilised CPU is associated with its former virtual partition. A second interrupt signal is generated at step 434 and forwarded to the operating system associated with the overloaded CPU. Referring to the fourth flow chart 408, the second interrupt signal is received or processed, at step 436. At step 438, a mapping is created between the CPU, or its corresponding hardware path, and a logical representation of that resource in the resource mapping data associated with the operating system having the overutilised CPU. Return data providing an indication of the insertion or inclusion of the newly migrated CPU into the resource mapping data associated with the operating system having the overutilised CPU is created at step 440 and returned to the partition monitor 328, or, for example, to the exception signal generator 366, at step 442.

Returning to the second flow chart 404, the return data providing an indication of the inclusion in the resource mapping data of a mapping between the newly migrated CPU and a corresponding logical representation of that CPU is received at step 444. Also, the return data received at step 444 is used to updated the virtual partitions database 336 to reflect the availability of the migrated CPU to the operating system associated with the overutilised CPU.

It will be appreciated from the above that the daemon 334 makes a determination as to whether or not resources in partitions are overutilised or underutilised, that is, a determination as to whether or not current utilisations of respective resources is acceptable. One skilled in the art appreciates that any such determination can be made in a number of ways. For example, if the resource to be assessed is memory, the determination might be related to the current utilisation of that portion of physical memory 314 assigned to a virtual partition. As another example, if the resource to be assessed is a processor, the determination as to whether or not use of that processor is acceptable or unacceptable might involve a percentage utilisation of that processor within or over a predetermined period of time being above a utilisation threshold such as, for example, the average utilisation of the processor over a 5 minute period was greater than 90%. Assuming that the resource to be monitored is the LAN, the determination as to whether or not use of LAN is acceptable might be based on a current percentage utilisation of that LAN or on an average utilisation of that LAN over a predetermined period. For example, one might have a situation in which a LAN's bandwidth is saturated, that is, the applications are generating such an amount of data that it uses the bandwidth available. In relation to, for example, I/O cards, the number of I/Os issued and their capacities assigned to various partitions might be varied, that is, migrated between overutilised partitions.

Although the above embodiments have been described with reference to the daemons 334 monitoring the workloads of the CPUs 304 to 310, embodiments are not limited to such an arrangement. Embodiments can be realised in which the daemon 334 is arranged to monitor the workload or resource utilisations of the virtual partitions 330 and 332 by, in effect, monitoring the combined workloads of any CPUs assigned to those partitions.

It will be appreciated from the above that the embodiments have been described with reference to the operating systems 350 and 352 both being UNIX operating systems. However, embodiments can be realised in which the operating systems are some of the operating system such as, for example, LINUX, Windows or any other multiprocessor or multitasking operating system. Furthermore, the operating systems 350 and 352 need not be the same operating system. One skilled in the art will appreciate that the operating systems 350 and 352 can be different operating systems.

The embodiments above have been described with reference to the virtual partitions monitor 328 supporting two virtual partitions. However, embodiments can be realised in which some other number of virtual partitions is supported.

Although the above embodiments have been described with reference to migrating CPUs between virtual partitions, embodiments are not limited to such an arrangement. Embodiments can be realised in which any other resource can be migrated between virtual partitions, that is, made available for use by or within those partitions. For example, underutilised memory initially assigned to one virtual partition may be made available to another virtual partition in the event that the other virtual partition's memory utilisation is high, that is, has exceeded a predetermined threshold.

The above embodiments have been described with reference to the daemon 334 monitoring the workloads of all of the CPUs 304 to 310. However, embodiments can be realised in which the daemon 334 is arranged to monitor a subset of the CPUs 304 to 310. For example, the daemon 334 can be arranged in monitor a single CPU such as, for example, the first CPU 304 or any other number of CPUs.

The above embodiments have been described with reference to the exception signal or signals having the highest priority of, or at least no lower priority than, any other operating system interrupts. However, embodiments are not limited to such arrangements. Embodiments can be realised in which the exception signal or signals has or have a different priority or different priorities.

The above embodiments have been described with reference to monitoring resources or determining whether or not a resource is overutilised. However, embodiments can be realised in which the monitoring or determining is performed at a different level or different level of granularity. For example, an embodiment can be realised in which the monitoring is performed at the partition level, that is, vPars Monitor 328 is arrange to respond to virtual partitions being overloaded rather than a mere processor of a virtual partition being overloaded. Such embodiments can then deal with situations in which within a partition, one CPU might be overloaded while another CPU is underloaded, for example, due to scheduling or its application type. Therefore, a temporary situation can arise in which one of the CPUs is overloaded. Hence, embodiments can be realised in which resource reassignment is instigated upon determining that the whole partition is overloaded. Therefore, references in the above embodiments to resources being overloaded, underloaded, overutilised or underutilised can be replaced or at least supplemented by, references to the partitions being overloaded, underloaded, overutilised or underutilised. In effect, the monitored resources comprise software entities such as, for example, the virtual partitions, as well as or instead of hardware entities.

Although the embodiments describe the exception signals as “first” and “second” signals this is not necessarily intended to connote a temporal order of generating the signals and embodiments can be realised in which the first and second exception signals are generated substantially simultaneously or in any other order. The substantially simultaneous generation of the exception signals results in activities associated with the respective operating systems within each partition being suspended.

The above embodiments have been described with reference to selecting an underutilised resource to be migrated. It will be appreciated that such an underutilised resource might be a resource that is not being used at all. In effect, the predetermineable utilisation used in embodiments of the present invention to determine whether or not a resource is a candidate for migration includes zero utilisation.

It will be appreciated that the applications referred to above are merely examples of programs or any other executable entities. Embodiments have been described with reference to using a signal. However, the term signal is intended to be sufficiently broad to encompass at least one of data, a message, a parameter or any other technique or method for communicating or any combination thereof.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A data processing system, comprising:
a plurality of hardware resources;
first and second execution environments arranged to support execution of first and second programs respectively using respective resources of the plurality of hardware resources; and
means to reassign resources associated with the second execution environment to the first execution environment in response to determining that the utilization of a resource associated with the first execution environment is unacceptable.

2. The data processing system as claimed in claim 1, in which the first and second execution environments comprise first and second virtual partitions, respectively.

3. The data processing system as claimed in claim 1 in which at least one of the first and second resources comprises at least one of a processor, memory and an I/O device

4. The data processing system as claimed in claim 1 in which the means to reassign is arranged to monitor utilization of the first resource to determine whether or not that utilization has a predetermined relationship with a utilization measure and in which the means to reassign reassigns the second resource associated with the second execution environment to the first execution environment in response to determining that utilization has the predetermined relationship with the criterion.

5. The data processing system as claimed in claim 4 in which the resource comprise a processor and in which the utilization measure is associated with the load of the processor.

6. The data processing system as claimed in claim 4 in which the resource is memory and the utilization measure is associated with the utilization of the memory.

7. The data processing system as claimed claim 1 in which the means to reassign comprises a first operating system associated with the first execution environment and a second operating system associated with the second execution environment and an exception signal generator arranged to issue a first signal to the second operating system in response to determining that the utilization of the first resource is unacceptable to cause the second operating system to relinquish control over the second resource and to issue a second signal to the first operating system to assign the second resource to the first operating system.

8. The data processing system as claimed in claim 7 in which the first and second signals are interrupt signals.

9. (canceled)

10. A data processing system, comprising:
a monitor to receive an output from a daemon; the daemon being arranged to monitor utilization of a first resource associated with a first entity and to produce the output in response to detecting a predetermineable utilization measure;
an exception signal generator arranged to a generate, in response to receiving the output, a first signal associated with removal of a second resource associated with a second entity, and to generate a second signal to associate the second resource with the first entity.

11. A data processing system, comprising:
a daemon to monitor utilization of a first resource associated with a first entity and to produce an output in response to detecting a predetermineable utilization measure;
an exception signal generator, responsive to the output, to produce at least a pair of a signals to disassociate a second resource from a second entity and to associate the second resource with the first entity.
an operating environment (operating system and/or first virtual partition) to support execution of the second entity; the environment being response to receiving the signal, of the pair of signals, to disassociate second resource and the second entity to disassociate the second resource and the second entity;
a further operating environment (operating system and/or first virtual partition) to support execution of the first entity using the first resource; the environment being response to receiving the signal, of the pair of signals, related to associating the second resource with the first entity.

12. A data processing system, comprising:
a plurality of hardware resources;
a daemon to monitor utilization of a first resource of the hardware resources associated with a first entity and to produce an output in response to detecting a predetermineable utilization measure;
an exception signal generator arranged to produce at least a pair of a signals to disassociate a second resource and a second entity and to associate the second resource with the first entity such that the signal of the pair of signals related to disassociating the second resource and the second entity is produced in response to the output;
a virtual partition comprising a respective operating system arranged to support execution of the second entity; the operating system being arranged to disassociate the second resource and the second entity in response to the signal related to disassociating the resource associated with the second entity;
a further virtual partition comprising a respective operating system arranged to support execution of the first entity using the first resource; the operating system of the further virtual environment being arranged to associate the second resource with the first entity in response to the signal related to associating the second resource with the first entity.

13. A method for managing resources of a computer having pair of virtual partitions comprising assigned respective resources for executing respective programs; the method comprising the steps of
monitoring the utilization of the respective resources to determine whether or not at least one resource thereof has a predetermined relationship relative to a performance metric;
identifying a resource that does not have such a predetermined relationship relative to the performance metric;
assigning the resource not having the predetermined relationship relative to the performance metric to virtual partition associated with the resource determined as having the predetermined relationship relative to the performance metric.

14. (canceled)

15. The data processing method as claimed in claim 13 further comprising the steps of establishing the first and second execution environments, which comprises creating the first and second virtual partitions and launching respective operating systems within the first and second virtual partitions to support execution of first and second applications respectively within the first and second virtual partitions.

16. The data processing method as claimed in claim 15 further comprising the step of assigning the first resource to the first partition and assigning the second resource to the second partition.

17. (canceled)

18. (canceled)

19. (canceled)

20. The data processing system as claimed in claim 5 in which the resource is memory and the utilization measure is associated with the utilization of the memory.

21. The data processing system as claimed in claim 2 in which the means to reassign comprises a first operating system associated with the first execution environment and a second operating system associated with the second execution environment and an exception signal generator arranged to issue a first signal to the second operating system in response to determining that the utilization of the first resource is unacceptable to cause the second operating system to relinquish control over the second resource and to issue a second signal to the first operating system to assign the second resource to the first operating system.

22. The data processing system as claimed in claim 3 in which the means to reassign comprises a first operating system associated with the first execution environment and a second operating system associated with the second execution environment and an exception signal generator arranged to issue a first signal to the second operating system in response to determining that the utilization of the first resource is unacceptable to cause the second operating system to relinquish control over the second resource and to issue a second signal to the first operating system to assign the second resource to the first operating system.

23. The data processing system as claimed in claim 4 in which the means to reassign comprises a first operating system associated with the first execution environment and a second operating system associated with the second execution environment and an exception signal generator arranged to issue a first signal to the second operating system in response to determining that the utilization of the first resource is unacceptable to cause the second operating system to relinquish control over the second resource and to issue a second signal to the first operating system to assign the second resource to the first operating system.

24. The data processing system as claimed in claim 5 in which the means to reassign comprises a first operating system associated with the first execution environment and a second operating system associated with the second execution environment and an exception signal generator arranged to issue a first signal to the second operating system in response to determining that the utilization of the first resource is unacceptable to cause the second operating system to relinquish control over the second resource and to issue a second signal to the first operating system to assign the second resource to the first operating system.
